(19) United States
(12) Patent Application Publication
(10) Pub. No.: US 2024/0117898 A1
(43) Pub. Date: Apr. 11, 2024

(54) FIRE BARRIER CAP FOR SHOWER VALVES

(71) Applicant: James N. Koehler, Las Vegas, NV (US)

(72) Inventor: James N. Koehler, Las Vegas, NV (US)

(21) Appl. No.: 18/238,374

(22) Filed: Aug. 25, 2023

Related U.S. Application Data
(60) Provisional application No. 63/413,520, filed on Oct. 5, 2022.

(51) Int. Cl. F16L 5/04

(52) U.S. Cl. CPC F16L 5/04

(57) ABSTRACT

In an embodiment of the disclosed principles, a fire barrier penetration sealer is disclosed for sealing an opening in a fire barrier, such as but not limited to a wall, at the location of penetration. The fire barrier penetration sealer may include an annular face plate having a front face and a back face. A continuous projection extends concentrically from the back face of the annular face plate. An inner intumescent strip covers the inner surface of the projection, and an outer intumescent strip covers the outer surface of the projection, such that the annular face plate and the connected continuous projection fit over the object penetrating the fire barrier when the fire barrier penetration sealer is placed over the opening in the fire barrier with its front face facing outward. In the event of a fire, the heat of the fire or hot gases will expand the intumescent materials, thereby sealing the penetration.

### RELATED APPLICATIONS

This application is a continuation of and claims priority to U.S. Provisional Patent Application Ser. No. 63/413,520, filed Oct. 5, 2022, entitled Fire Barrier Cap for Shower Valves, which application is herein incorporated by reference in its entirety for all that it teaches, shows and suggests, without exclusion of any portion thereof.

### TECHNICAL FIELD

The present specification relates to thermal barriers and, more particularly, to fire-resisting thermal barriers. More specifically, the disclosed principles relate to a fire barrier cap for mounting in a fire barrier wall overlying structural breaches.

### BACKGROUND

A fire barrier wall in a building acts as part of the passive fire protection system to prevent or delay the spread of fire. Building codes require specified fire-resistance ratings for the interior walls and ceilings of commercial buildings, depending upon their location and the nature of their use within the commercial structure. In addition, fire ratings are frequently specified based upon duration (for example, a 1-hour minimum resistance) under standardized test conditions.

Most commercial buildings have recessed fixtures in walls spaced along the corridors and in demising walls. Such recessed fixtures may include fire extinguisher cabinets, fire hose cabinets, electrical panels, wall safes, eyewash stations, utility controllers, dryer vent boxes, shower valves, plumbing feeds, and speaker boxes. At such locations, the breach in fire-resistant material required for the inset feature is termed a “membrane penetration.” Upon completion of the wall or corridor, building codes require compliance of the entire wall, including any insets, with the required fire-resistance rating. As such, any breaches resulting from installing recessed fixtures cannot reduce the required fire rating of the wall or partition.

By way of example and not limitation, shower valves present a challenging membrane penetration to address. Besides the complexities of a moving valve, their construction includes many supply lines and an often nonmetallic escutcheon plate. Creating a fire barrier for a shower valve penetration is difficult enough in new construction, and applying existing solutions in a retrofit application is not economically feasible.

Before proceeding, it should be appreciated that while the present disclosure is directed to a system that may address some of the shortcomings listed or implicit in this Background section, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

In an embodiment of the disclosed principles, a cap of metallic construction is provided, having a circular base plate with a center opening and a protruding ring. The inside surface of the ring is lined with an intumescent strip such as, but not limited to, 3M™ FSI95 (3M Fire Protection Products, www.3m.com/firestop). An additional intumescent strip, such as 3M™ Ultra GS (3M Fire Protection Products, www.3m.com/firestop), adheres to the outside surface of the ring. Placement of the cap coincident with a precut hole in the gypsum centered on the shower valve enables insertion of the ring, which is also centered on the shower valve. The base rests against the gypsum wall adjacent the opening. In an embodiment, no additional means is used for securing it in place. The ring structure allows the outside intumescent strip to seal between the ring and the gypsum hole and the inner intumescent strip sealing from the ring to the shower valve.

In a further embodiment, a fire barrier wall penetration sealer is disclosed for sealing an opening in a fire barrier wall at a penetration of an object through the fire barrier wall. The fire barrier wall penetration sealer may include an annular face plate having a front face and a back face, as well as a primary faceplate axis. A cylindrical projection connected to and extending from the back face of the annular face plate has a primary axis substantially concentric with the primary faceplate axis. An inner intumescent strip substantially covers the inner surface of the cylindrical projection, and an outer intumescent strip substantially covers the outer surface of the cylindrical projection. When deployed, the annular face plate and the connected cylindrical projection fit over and at least partly surround the object penetrating the fire barrier wall when the fire barrier wall penetration sealer is placed over the opening in the fire barrier wall with its front face facing outward.

In a further embodiment, the object penetrating the fire barrier wall is a plumbing fixture. In yet a further embodiment, the plumbing fixture is a water valve including a stem. In an embodiment, the penetration may be in a corridor, or may be in a demising wall or otherwise.

In a yet another embodiment, the fire barrier may be a wall, a floor or a ceiling. The space between the inner intumescent strip and the valve provides access to any shutoff screws on the valve, and the fire barrier penetration sealer can be installed without the use of fastening or caulking material and may be uninstalled or have its position adjusted after installation. In an embodiment, the fire barrier penetration sealer is configured for back to back installation with another fire barrier penetration sealer of the same type.

Other features and aspects of the disclosed principles will be apparent from the detailed description taken in conjunction with the included figures.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 illustrates in perspective view the utilization of the disclosed principles in a shower valve fixture membrane penetration in a fire barrier wall, in accordance with one embodiment.

FIG. 2A illustrates in perspective view a base plate in accordance with one embodiment.

FIG. 2B illustrates in top plan view a base plate in accordance with one embodiment.

FIG. 3A illustrates in perspective view a protruding ring in accordance with one embodiment.

FIG. 3B illustrates in top plan view a protruding ring in accordance with one embodiment.

FIG. 3C illustrates in side elevation view a protruding ring in accordance with one embodiment.

FIG. 4A illustrates in perspective view, with portions shown in phantom, a fire barrier cap in accordance with one embodiment.

FIG. 4B illustrates in top plan view, with portions shown in phantom, a fire barrier cap in accordance with one embodiment.

FIG. 4C illustrates in side elevation view, taken in cross-section through a diameter of a fire barrier cap, in accordance with one embodiment.

FIG. 5 illustrates in perspective view a fire barrier cap and unmounted inner intumescent strip and outer intumescent strip in accordance with one embodiment.

FIG. 6 illustrates in perspective view a fire barrier cap with attached inner intumescent strip and outer intumescent strip in accordance with one embodiment.

FIG. 7 illustrates in partial perspective view a shower valve installed within a wallboard—steel channel stud wall, the front wallboard not yet attached, in accordance with one embodiment.

FIG. 8 illustrates in perspective a shower valve installed within a wallboard—steel channel stud wall and visible through an install aperture formed in the front wallboard in accordance with one embodiment.

FIG. 9 illustrates in side plan view a fire barrier cap placed within an install aperture in accordance with one embodiment.

FIG. 10 illustrates in diagrammatic view a fire barrier cap installed in a shower fixture membrane penetration in accordance with one embodiment.

FIG. 11 illustrates in partial perspective a test wall assembly, post-fire test, that includes a pair of fire barrier caps, one on the fire-side of the test apparatus and the other on the away-side in accordance with one embodiment.

FIG. 12 illustrates in partial perspective a rear housing of an away-side shower valve, post-fire test, in accordance with one embodiment.

FIG. 13 illustrates in partial perspective an enlarged view of an away-side shower valve, post-fire test, similar to FIG. 12, in accordance with one embodiment.

FIG. 14 illustrates in a side perspective view back-to-back shower valves in a test wall assembly, post-fire test that includes a pair of fire barrier caps, one on the fire-side of the test wall assembly and the other on the away-side in accordance with one embodiment.

FIG. 15 illustrates, in a side perspective view, a shaftwall test assembly having shower valves on the fire-side and the away-side in accordance with one embodiment.

FIG. 16 illustrates in a side perspective view a shaftwall test assembly placed in a presentation frame adjacent to an open side of a fire test furnace in accordance with one embodiment.

FIG. 17 illustrates in a side perspective view a post-fire test shaftwall test assembly in accordance with one embodiment.

FIG. 18A illustrates in perspective view, with portions shown in phantom, a base plate in accordance with an alternative embodiment.

FIG. 18B illustrates in top plan view a base plate in accordance with the alternative embodiment of FIG. 18A.

FIG. 18C illustrates in side elevation view a protruding ring in accordance with the alternative embodiment of FIGS. 18A and 18B.

FIG. 19 illustrates in a top plan view a fire barrier cap in accordance with the alternative embodiment of FIGS. 18A-18C.

FIG. 20A diagrammatically illustrates a fire barrier cap installed in an alternative shower fixture membrane penetration in accordance with the alternative embodiment of FIGS. 18-19.

FIG. 20B diagrammatically illustrates a fire barrier cap installed in an alternative shower fixture membrane penetration in accordance with the alternative embodiment of FIGS. 18-19.

FIG. 20C diagrammatically illustrates a fire barrier cap installed in an alternative shower fixture membrane penetration in accordance with the alternative embodiment of FIGS. 18-19.

FIG. 20D diagrammatically illustrates a fire barrier cap installed in an alternative shower fixture membrane penetration in accordance with the alternative embodiment of FIGS. 18-19.

To quickly identify the discussion of any particular element or act, the most significant digit or digits in a reference number refer to the figure number in which that element is first introduced.

### DETAILED DESCRIPTION

As noted above, a commercial building may have recessed fixtures in walls, and the breach in fire-resistant material required at such locations cannot be permitted to reduce the required fire rating of the wall or partition. To this end, in an embodiment of the disclosed principles, a fire barrier cap is provided for placement over a valve fixture membrane penetration in a fire barrier wall.

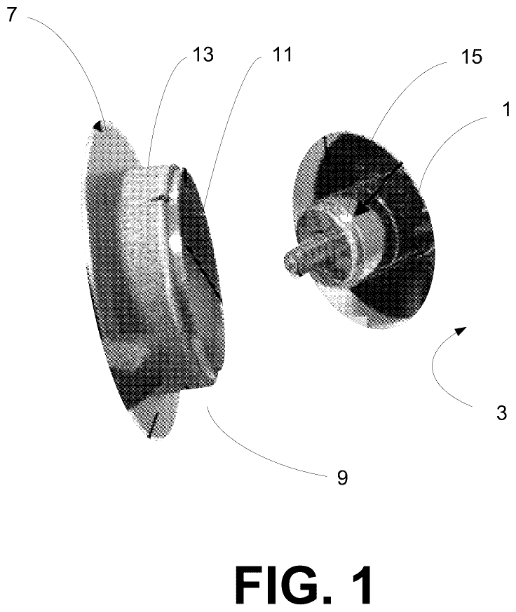

With this overview in mind, we turn now to a more detailed discussion of the disclosed principles in conjunction with the attached figures. Turning more specifically to the figures, FIG. 1 illustrates the use of an embodiment of the present innovation in a fixture membrane penetration resulting from installing a shower valve 15. A fixture aperture 1, e.g., hole, formed at the installation location in a fire barrier wall 3—typically gypsum wallboard—creates a fixture membrane penetration. A fire barrier cap 5 having a base plate 7 and a protruding ring 9 is sized for receipt within the fixture membrane penetration, the protruding ring 9 extending within the penetration.

Inside and outside surfaces of the protruding ring include attached strips of intumescent material—both an inner intumescent strip 11 and an outer intumescent strip 13. Intumescent material is material that swells when exposed to heat, causing an increase in volume and decrease in density. In a fire condition in the described configuration, both strips 11, 13 expand, sealing the fixture membrane penetration, such that there is no airgap through the membrane (e.g., no gap through the gypsum of the wall).

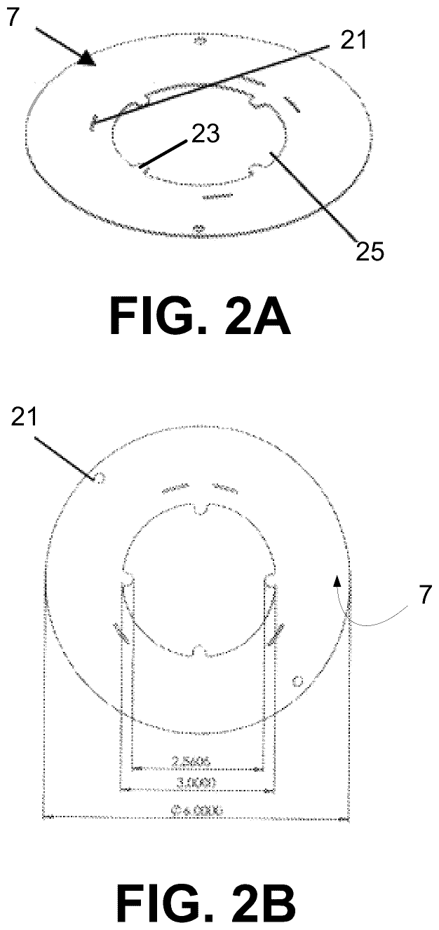

The base plate 7 in FIG. 2A is in perspective view, showing multiple TIG (“Tungsten Inert Gas”) weld slots 21 and several aperture tabs 23 extending from an inner circular aperture 25. FIG. 2B provides a plan view showing an example of presently preferred diameters in inches.

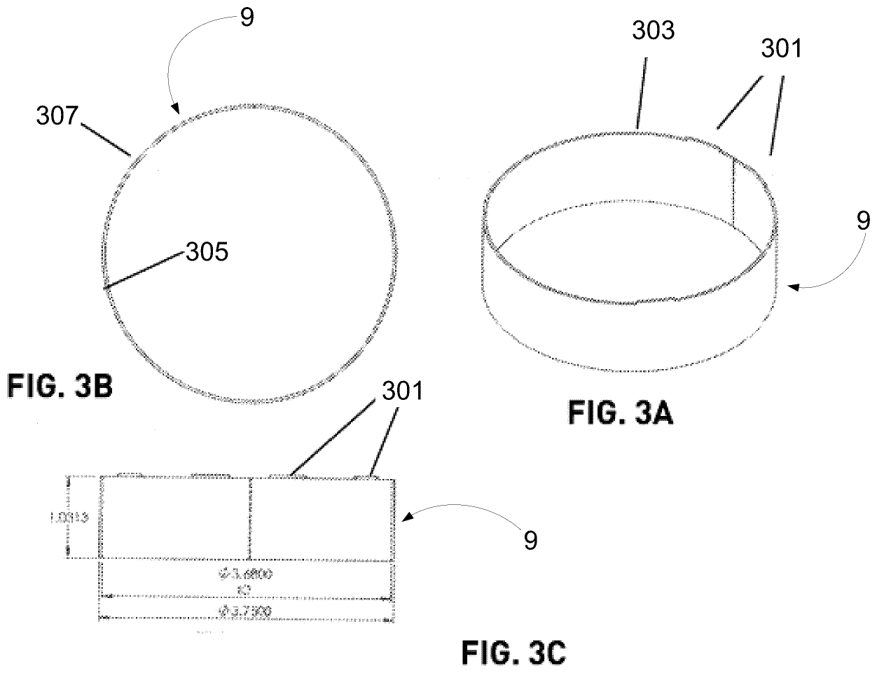

The protruding ring 9 is shown in greater detail in FIGS. 3A, 3B, and 3C. FIG. 3A shows the protruding ring 9 in perspective view, with tabs 301 shown extending from a base plate edge 303 and inner and outer surfaces 305, 307. FIG. 3B shows the protruding ring in top plan view, with a side elevation view of the protruding ring shown in FIG. 3C. Presently preferred dimensions are also shown in FIG. 3C, including inner diameter, outer diameter, and the preferred height of the protruding ring (excluding the height of the welding tabs).

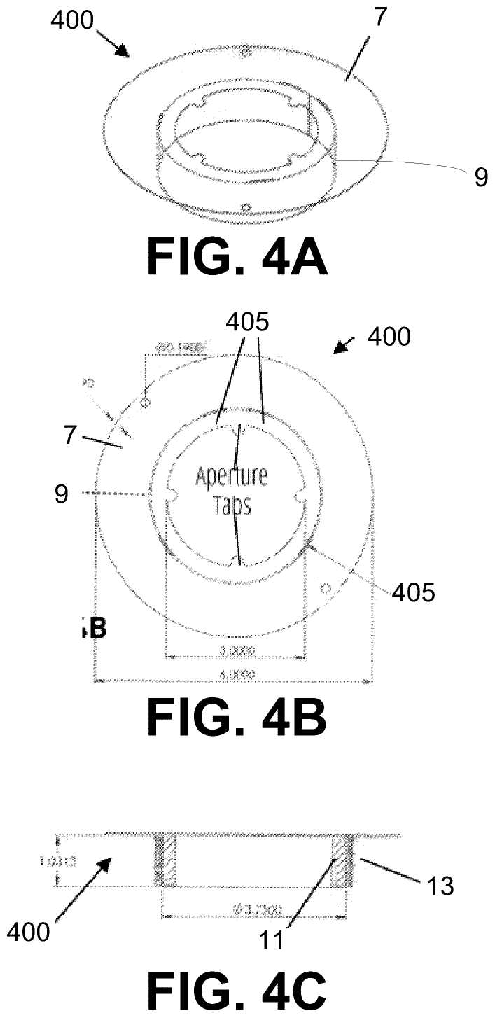

FIGS. 4A, 4B, and 4C show in perspective view the assembled fire barrier cap 400, with parts shown in phantom in FIG. 4A, in a top plan view, with portions shown in phantom in FIG. 4B, and in a side elevation view in FIG. 4C. The protruding ring 9 attaches to the base plate 7 at multiple welded attachment locations in the base plate 7.

The attachments are formed where a welding tab of the protruding ring 9 is received and then welded within a corresponding welding slot formed in the base plate 7. Preferably, as shown in FIG. 4B, the attachment locations create a circular welded attachment pattern 405 about the interior aperture.

The side elevation view of FIG. 4C includes a cross-sectional view of the protruding ring 9, downwardly extending from the base plate 7. The inner ring surface has attached an inner intumescent strip 11, and the outer ring surface has an attached outer intumescent strip 13. The intumescent strips 11, 13 are preferably formed of different intumescent materials (see discussions below).

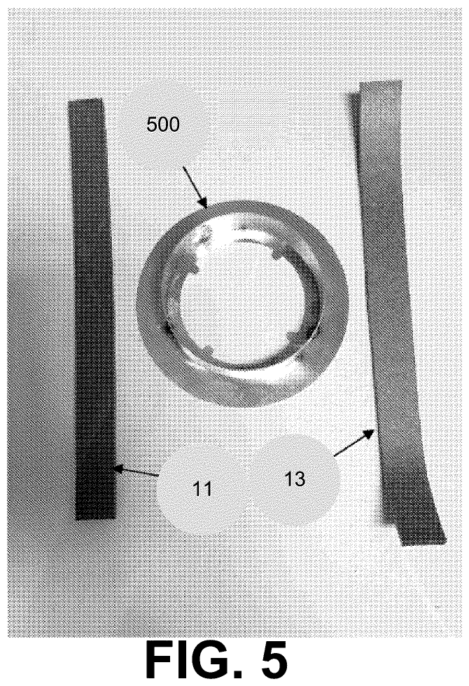

In a presently preferred embodiment, and by way of example and not limitation, FIG. 5 shows the fire barrier cap 500 and a pair of unattached intumescent strips 511, 513. The inner intumescent strip 11 is preferably a 3M™ brand Fire Barrier Wrap Strip FS-195+, which provides effective firestops for metallic and nonmetallic penetrants. Although not shown in FIG. 5, the inner intumescent strip 11 wraps around the inner wall of the protruding ring 9 in a friction-fit construction.

The outer intumescent strip is preferably a 3M™ Fire Barrier Ultra GS Wrap Strip, a graphite-based firestop, which is an effective firestop for metallic and nonmetallic penetrants. The outer strip is wrapped about the outer surface of the protruding ring, to which it is attached using a (preferably) 3M™ brand adhesive. Compared with the outer intumescent strip, the FS195 intumescent material for the inner intumescent strip is twice as thick and way more aggressive. In addition, its exposure to heat creates a tough char that provides an excellent barrier to heat transmission.

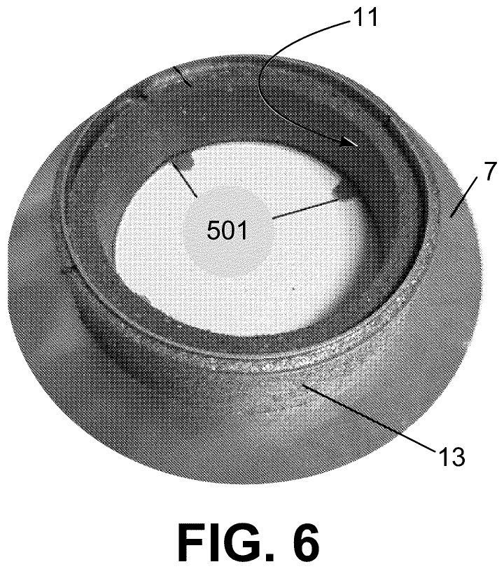

FIG. 6 provides a top perspective view of the resulting construction discussed above (reference FIG. 5). The friction-fit inner intumescent strip 11 rests against the inside surface of the protruding ring 9. The aperture tabs 501 inwardly extend from the bottom edge of the inside surface and assist in the initial positioning of the inner intumescent strip 11. Upon installation, the lower edge of the inner intumescent strip 11 rests against the upper annular surface of the base plate 7, between the protruding ring 9 and the inside edge of the inner circular aperture.

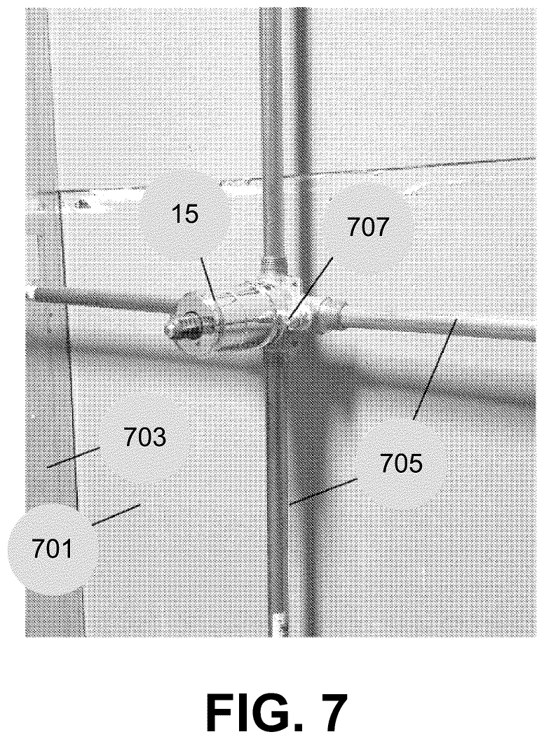

FIG. 7 shows a shower valve 15 installed in a wallboard/metal-steel channel stud wall. The rear wallboard 701 forms a fire barrier wall without fixture membrane penetrations. The front wallboard (not shown) is placed against the metal studs 703, creating a front fire barrier wall. The water supply lines 705 associated with the water shut off 707 extend within the cavity formed by the front and rear wallboards.

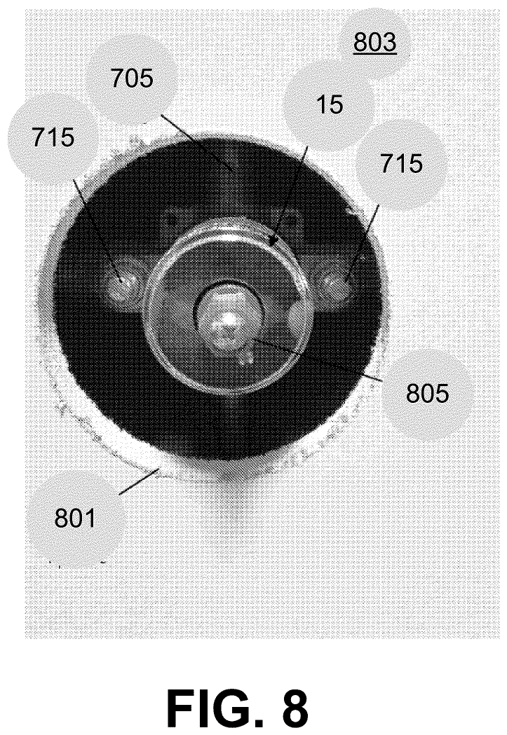

In FIG. 8, the front wallboard 803 is in place, with an install aperture 801 formed, vertically coinciding with the location of the shower valve 7 and stem 805. The install aperture 801 has a four-inch diameter in a preferred embodiment, although it can vary between four and five inches. The protruding ring has a preferred diameter of 3% inches. The addition of the outer intumescent strip results in a tight fit into a four-inch aperture. Where the install aperture 801 diameter exceeds four inches, up to the five-inch maximum, fasteners (preferably two #8×½-inch wafer screws) are optionally used to fasten the base plate to the front wallboard. The protruding ring is centered within the install aperture, and the outer extension of the base plate includes a pair of screw apertures formed therein for this purpose (see FIG. 2B).

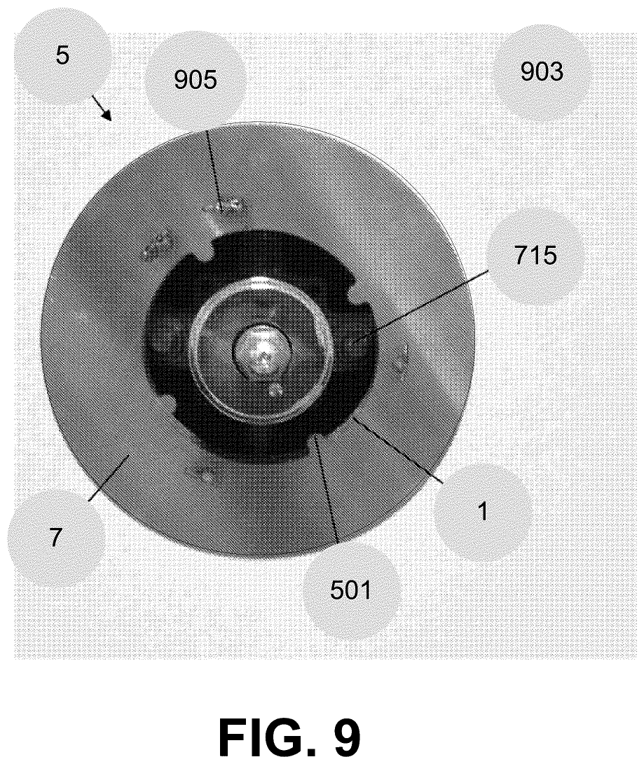

The fire barrier cap 5 is placed within the install aperture 1, as shown in FIG. 9, with the bottom surface of the base plate 7 coplanar with the front wallboard 903. The Tab/Slot welded connections 905 attach the base plate 7 to the protruding ring project from the bottom surface. The Tab/Slot welded connections 905 result from the insertion of the welding tabs into corresponding TIG weld slots formed in the base plate. TIG welding is preferably used, securely connecting the inserted tabs to the base plate.

With the protruding ring received within the shower valve install aperture formed in the front wallboard, the base plate is tight against the gypsum. The shower valve is centered within the inner circular aperture, leaving both water shut-off screws 715 accessible. Shut-off access greatly simplifies troubleshooting of the shower valve, enabling site-specific control of water low during repair or replacement of the shower valve.

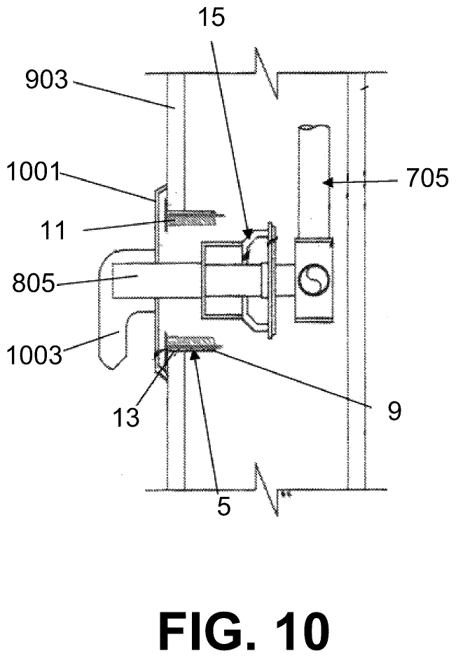

FIG. 10 provides a simplified diagrammatic representation of a shower valve fixture membrane penetration in a gypsum wallboard metal or wood-stud fire barrier wall. First, the protruding ring 9 of the fire barrier cap 5 is inserted in a shower valve install aperture 1. Next, an escutcheon plate 1001 is received by the valve stem 805 and is placed over the install aperture 1, sealing the wall opening. A handle 1003 is then attached to the valve stem 805, enabling a user (not shown) to rotate the valve stem 805 when operating the shower valve 15.

In a fire condition, heat applied to the outside front of the shower handle 1003 and escutcheon plate 1001 causes the expansion of the outer intumescent strip 13, sealing the outer perimeter of the fire barrier cap. Enlargement of the inner intumescent strip 11 fills the shower valve install opening 1, as discussed below.

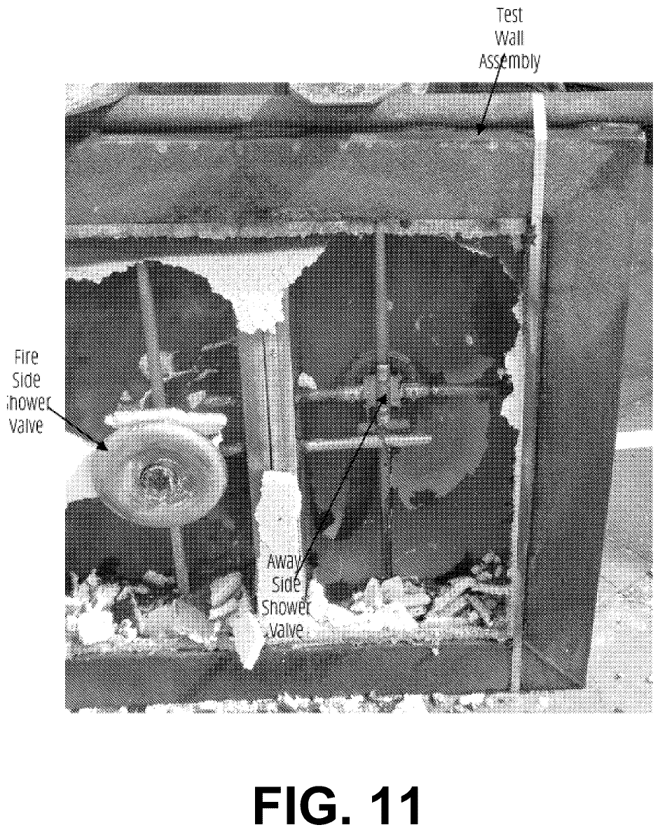

In FIG. 11, a test wall assembly is shown after being subjected to 1700° (F.) for one hour—the facing side exposed to the furnace, followed by a hose stream test at thirty pounds of water pressure for fifteen (15) seconds. The test wall assembly includes two separated shower-valve fixture membrane penetrations. Each penetration lies in an adjoining but separate wallboard stud wall section. In FIG. 11, they are identified as a “fire-side shower valve” and an “away-side shower valve.” Before the fire test, a fire barrier cap was installed to cover both shower valves.

Post-test, the fire-side shower valve is shown in FIG. 11, fronting the left stud wall section. A non-fire or away-side shower valve is at the rear of the right stud wall section. The outer intumescent strip is shown greatly expanded around the outer periphery of the fire-side shower valve.

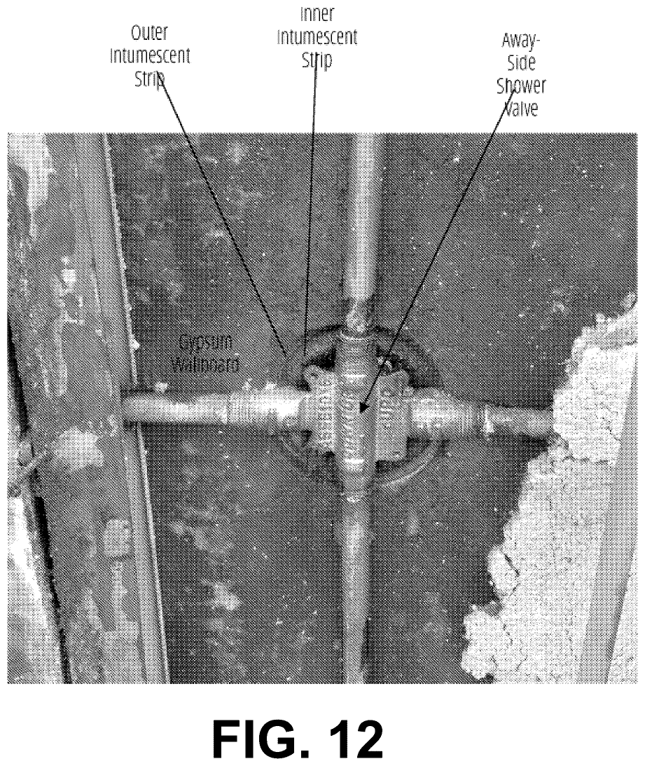

FIG. 12 shows the away-side shower valve, one with exposure to the non-fire side of the testing. The outer intumescent strip greatly expanded and tightly sealed the protruding ring's outer perimeter to the gypsum wallboard's adjacent surface. Similarly, the inner intumescent strip received by the inside surface of the protruding ring is shown to have expanded and is pressed in a sealing relationship against the shower valve.

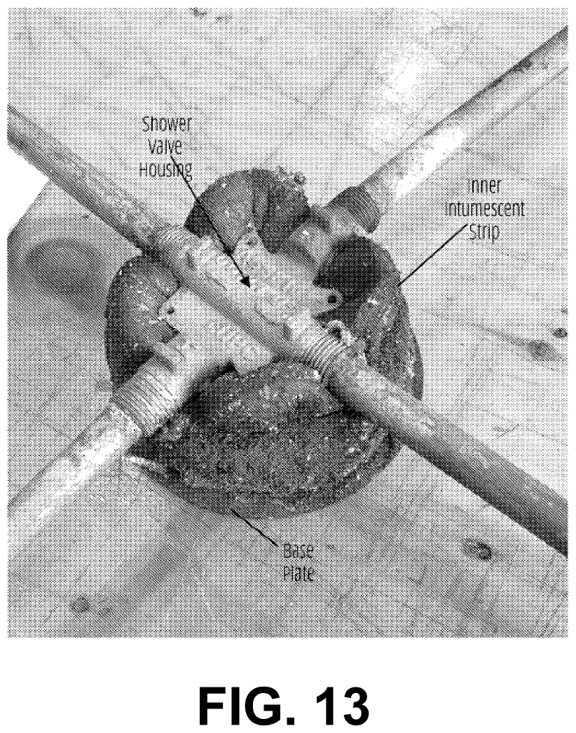

The “test-fire” applied significant heat to the wallboard behind the away-side shower valve. This heat was conveyed to the rear shower valve housing, triggering the expansion of the inner intumescent strip. FIG. 13 illustrates how tightly the inner intumescent strip seals to the shower valve toward maintaining the fire resistance of the wallboard stud wall.

FIG. 11 is a test construction to efficiently evaluate the fire barrier cap on fire-side shower valves and away-side shower valves. The room layout for multiple-room traveler lodgings, such as hotels and motels, frequently places bathrooms and their associated plumbing in a back-to-back manner separated by fire barrier walls. Such a room arrangement places the back-to-back shower valves in proximity.

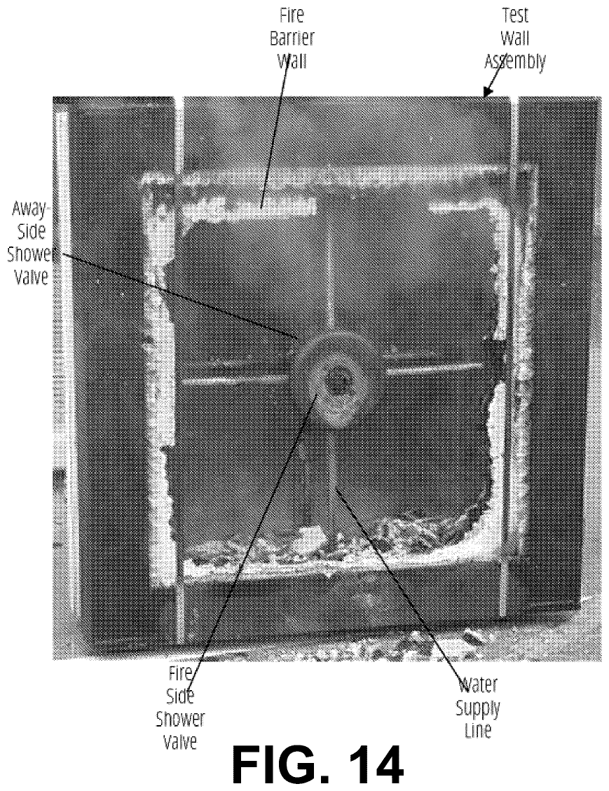

The test wall assembly in FIG. 14 shows back-to-back shower valves, each using a fire barrier cap. The facing side has experienced the 1700° (F.) furnace for one hour, followed by a hose stream test. The inner intumescent strip received by the inside surface of the protruding ring is shown in the facing side fire barrier cap to have expanded. It is pressed against the shower valve in a sealing relationship.

Under the disclosed principles, the proximity of the back-to-back shower valves and the fast transmission of the fire furnace heat are offset by the quick expansion of the intumescent strips. Delayed heat penetration through the fixture membrane penetrations is sufficient to maintain the required fire rating of the fire barrier wall of this test wall assembly.

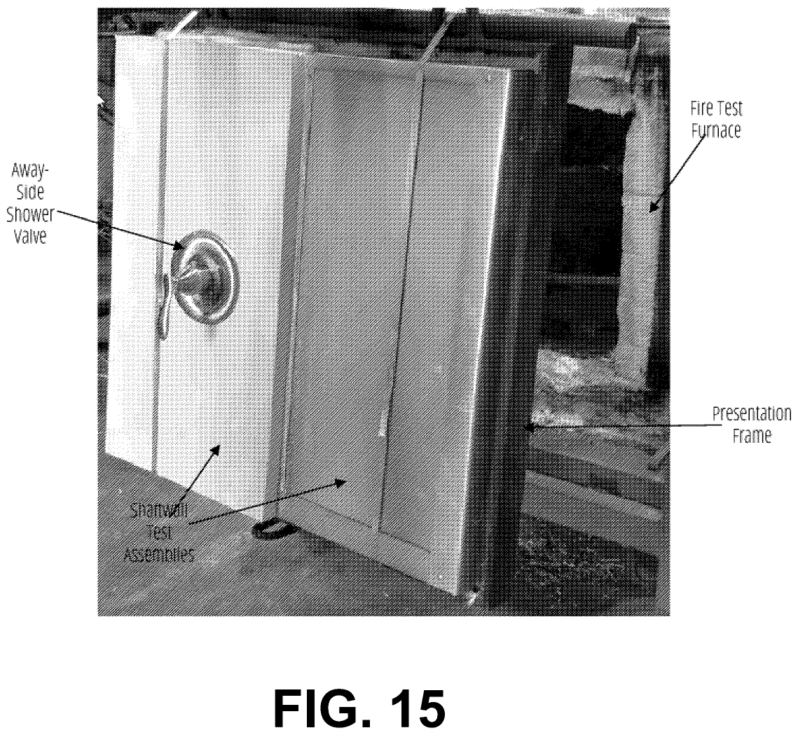

FIG. 15 shows the use of the disclosed principles in a shaftwall system. Shaftwalls are non-load-bearing, fire-rated wall assemblies. In buildings, they protect such structures as elevator shafts, stairwells, vertical chases, and mechanical enclosures. In FIG. 15, the test wall assembly, mounted within a presentation frame, places shower valves on both the fire and away sides. Fire barrier caps cover both shower valves.

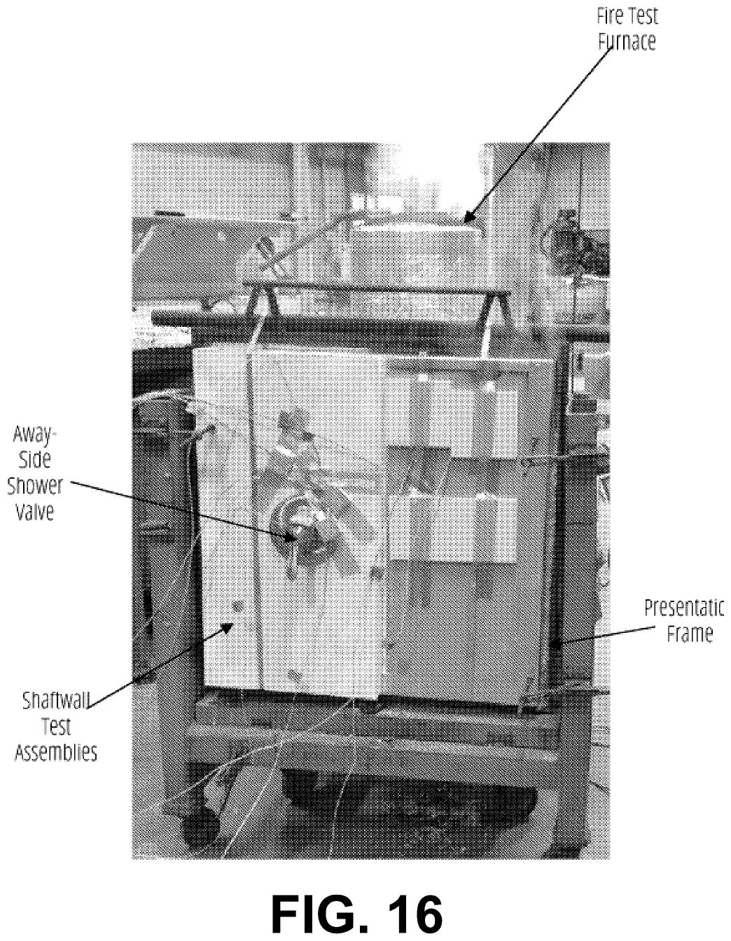

In FIG. 16, the shaftwall test assemblies within the presentation frame have been positioned before an open side of the fire test furnace. As so placed, the away-side shower valve and the back wallboard panel behind the fire barrier cap are exposed to 1700° (F.) from the fire test furnace for one hour. The hose stream test follows.

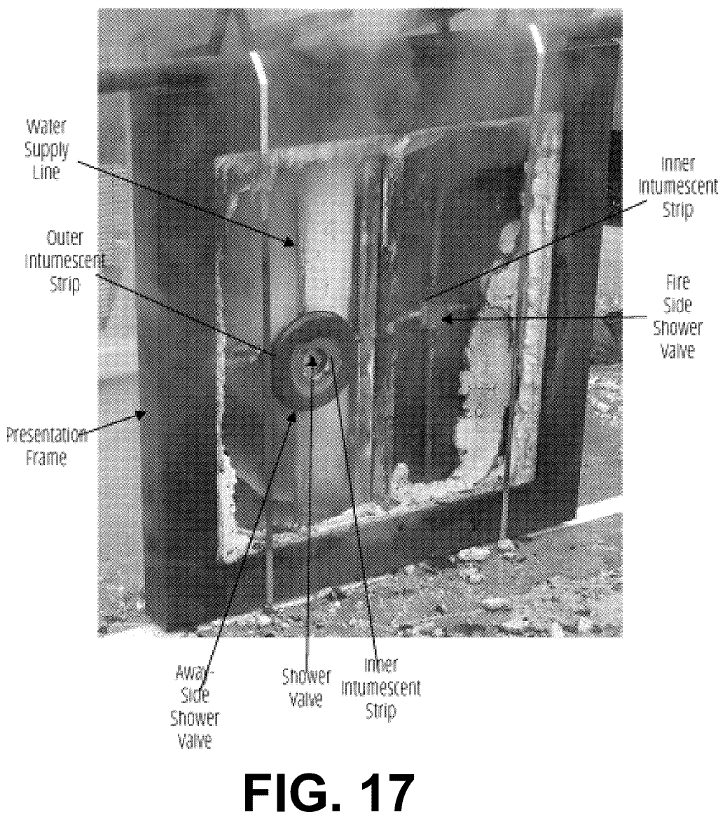

In FIG. 17, the front wallboard blasted away by the hose stream test, the expanded intumescent strips are visible and demonstrate their manner of preventing a shower valve membrane penetration of the fire barrier walls. The inner intumescent strips on the fire-side shower valve and the away-side have expanded and tightly surrounded the shower valve. Similarly, the expansion of the outer intumescent strip at its interface with the adjacent wallboard maintains the thermal integrity of the fire barrier wall.

A presently preferred alternative embodiment is also provided, enabling the use of the disclosed principles where openings to the shower valve are not precisely aligned with the valve stem or exhibit variance in opening diameter. The presently preferred alternative embodiment also provides enhanced access to the water shut-off controls for the shower fixture.

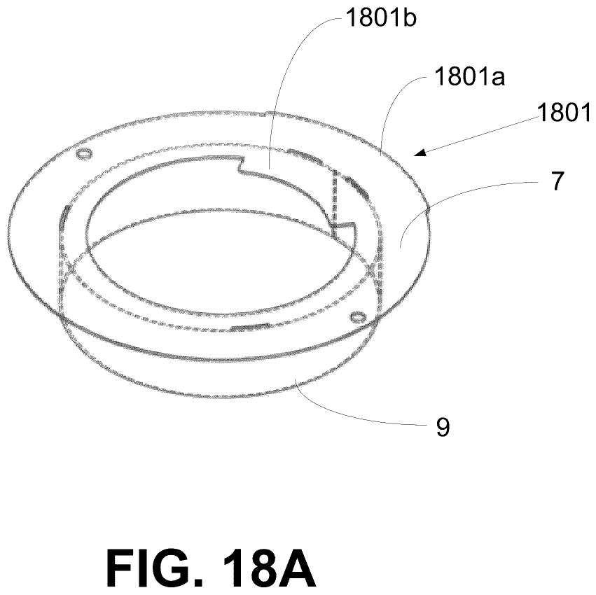

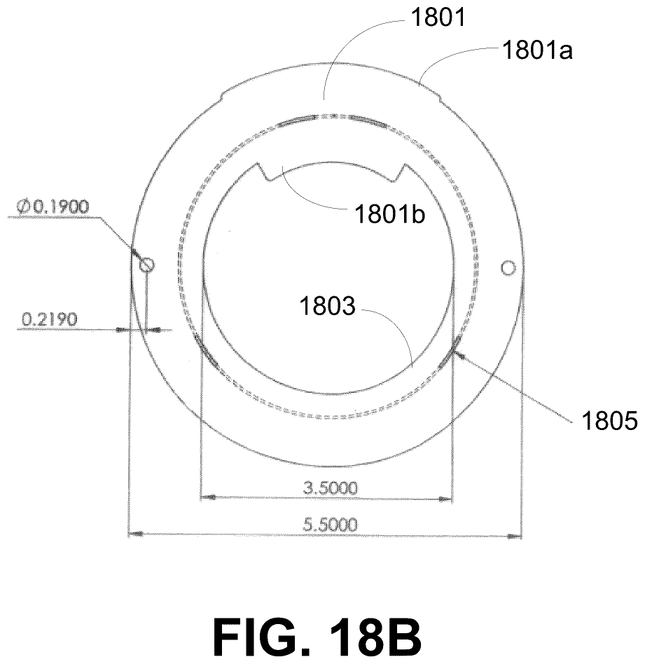

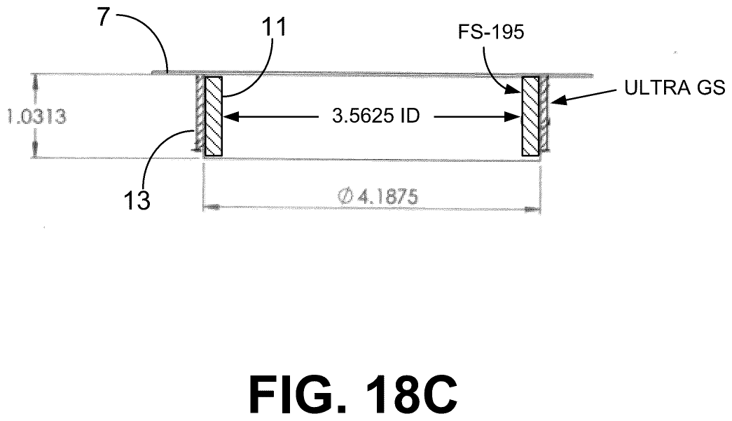

As shown in FIG. 18A, the fire barrier cap configuration is consistent with the fire barrier cap shown in FIGS. 2-4, fabricated by connecting a base plate 7 and a protruding ring 9. As best shown in FIGS. 18A and 18B, the base plate 7 has been modified to include a radial segment of enlarged surface area defining a label plate 1801. The enlarged surface area provides a location of attachment for part identification and Underwriter Laboratories (“UL”) labeling, as is discussed more fully below.

Shown best in FIG. 18B, the preferred diameter of the outer ring or face plate 7 has been reduced from six inches in the previous version to five and one-half inches in the presently preferred alternative embodiment. In addition to reducing material and shipping costs (smaller container) the reduction in diameter enables a better fit under smaller escutcheon plates. The diameter of the inner ring 9 is increased from three inches to three-and-one-half inches. The enlarged diameter of the inner ring 9 provides greater access to the water shut-off valves to the shower fixture. The ring may be removed for service of the valve but need not be. Repairing the shower valve typically requires first turning off the water supply. The greater access provided by the alternative embodiment of FIGS. 18A-18C reduces the number of times removal of the fire barrier cap is required to access the water shut-off valves.

As best shown in FIG. 18C, further access to the water shut-off valves is obtained by increasing the outer diameter of the protruding ring 9 from four inches to four-and-three-sixteenths inches. An inner intumescent strip 11 is positioned against the inner surface of the protruding ring 9, and the outward repositioning of the ring 9 further opens access to the shut-off valves 715.

As shown in FIG. 18B, the aperture tabs of the previous embodiment are no longer required, and have been removed. Instead, an intumescent strip support annulus 1803 inwardly extends from the inside surface of the protruding ring 9 inward of the weld line 1805. It receives the lateral edges of the intumescent strip (not shown) upon its installation in the fire barrier cap.

FIG. 18B also illustrates the structures defining the label plate 1803 formed within the upper surface of the base plate 7. An outer label platform 1801a is provided in the outer perimeter of the base plate 7, having a preferred outward projection of 1/16 inch that preferably extends along an arc length of approximately 2⅜ inches. An inner label platform 1803b extends between the base plate radii defining the arc length of the outer label platform 1803a and projects inwardly 5/16 inch from the inner ring aperture and extends along an arc length of approximately 1% inches. The outer ring 1801a has a radial length of preferably about one inch.

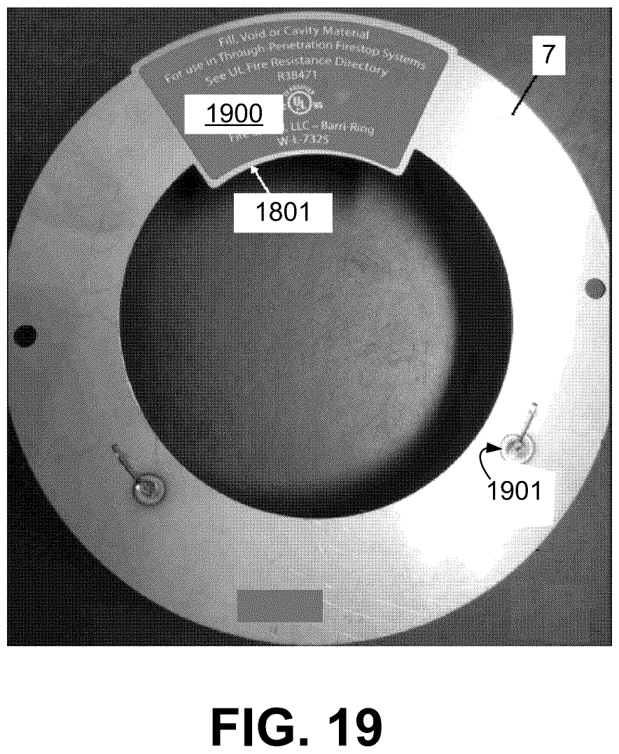

A fire barrier cap in accordance with the presently preferred alternative embodiment is shown in FIG. 19. A label 1900 is shown attached to the label plate. Welds 1901 are shown connecting the base plate 7 to the protruding ring 9 (blocked from view by the base plate 7), the tabs of the protruding ring having been first inserted into the slots formed in the base plate 7.

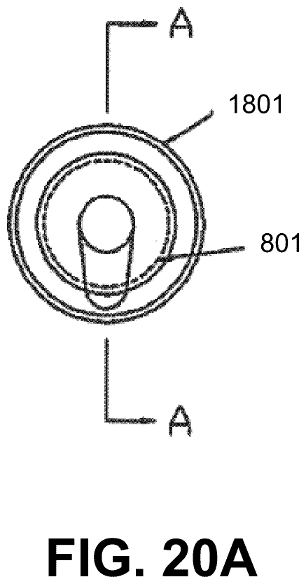

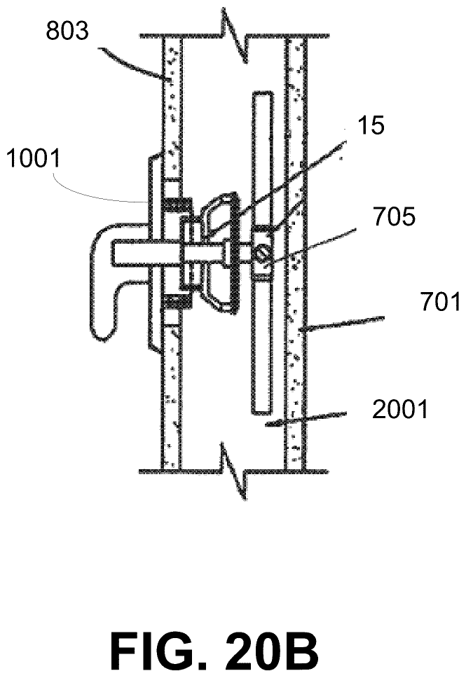

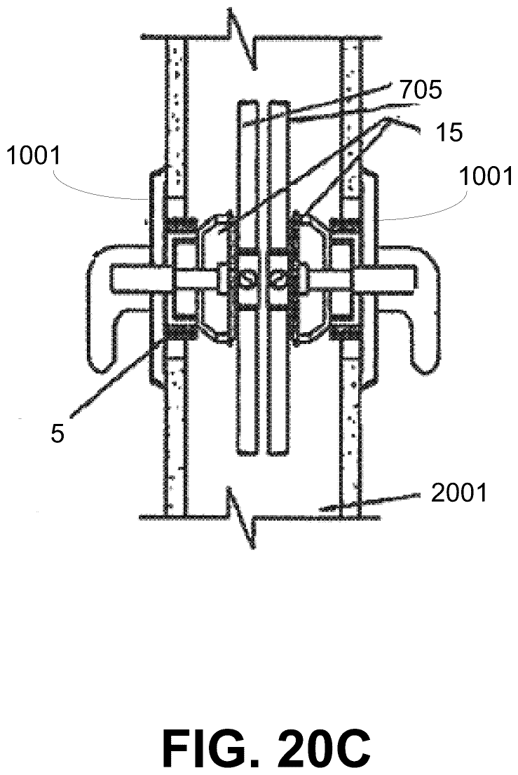

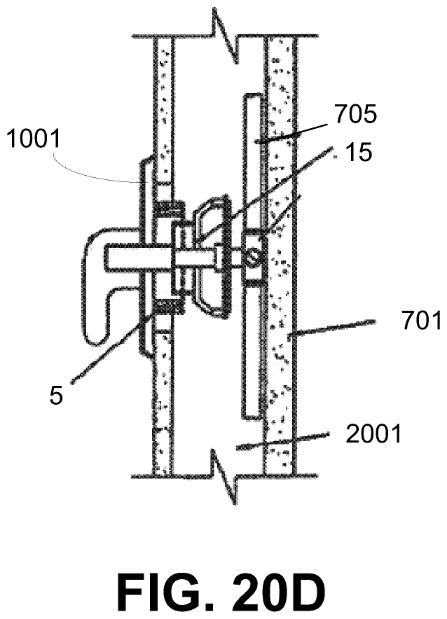

In a similar manner as FIG. 10, FIGS. 20A-20D provide simplified diagrammatic representations of a shower valve fixture membrane penetration in a gypsum wallboard metal- or wood-stud fire barrier walls. In addition, FIG. 20A shows a conventional single handle, tub/shower valve assembly installation where the shower handle is attached to and extends from the shower valve stem. An escutcheon plate covers a shower valve fixture opening in a fire barrier wall.

FIGS. 20B-20D provide diagrammatic cross-sections of alternative shower valve installations in fire barrier walls. By way of example and not limitation, a single handle tub/shower valve assembly includes an escutcheon plate 1001 with nonmetallic/nonferrous and stainless-steel materials connected to nominal ½-inch copper, brass, iron Crosslink Polyethylene (PEX), or solid or cell core Polyvinyl Chloride (PVC) supply pipes or tubes.

In the installations depicted in FIGS. 20B and 20C, the one or two-hour fire-rated framed gypsum board assembly is constructed of the materials and in the manner specified in the individual UL Fire Resistance Directory—U300, U400, V400, or W400 Series of wall and partitions designs. The wall-framing studs are thus steel channel studs or wood studs. Steel studs are to be a minimum of 3⅝-inches or 6-inches wide and spaced a maximum of 24 inches on center (“OC”). Wood studs are to be a minimum of two inches by four inches or larger and spaced a maximum of 16 inches OC. For back-to-back installations, such as in FIG. 20C, a minimum of 6-inch-wide studs are required.

The gypsum board type, thickness, number of layers, and orientation are as specified in the Wall and Partition Design. The cutout made to accommodate the fire barrier cap may have a maximum diameter of five (5) inches. The hourly F, T, FT, FH, and FTH Ratings of the fire barrier cap are equal to the hourly fire rating of the wall in which the fire barrier cap is installed.

The shaft wall assembly depicted in FIG. 20D requires the 1- or 2-hour fire-rated gypsum board/stud shaft wall assembly should be constructed of the materials and in the manner specified in the individual U400 and V400 Series Wall and Partition Designs in the UL Fire Resistance Directory and should incorporate the following construction features. The studs shall be fabricated in a “C—H” shape, of a minimum of 2½-inch wide by 1½-inch deep, manufactured from a minimum No. 25 gauge galvanized steel, and spaced a maximum of 24 inches, OC. The gypsum board shall be UL certified and 1-inch thick, 24 inches wide, and installed vertically. The maximum diameter of the opening into which the fire barrier cap is installed is 4½ inches.

As a result of the dimensional changes in the presently preferred alternative embodiment, (1) the reduced outer diameter of the base plate 7, from six inches down to five-and-one-half inches, (2) the increased inner diameter of the inner ring aperture from three inches to three-and-one-half inches; and (3) the increased outer diameter of the protruding ring 9 from four inches to four-and-three-sixteenths inches. These dimensional changes in the alternative embodiment enable the fire barrier cap to better adapt to minor changes in diameter and eccentric variances in the shower valve opening in the front wallboard.

In comparison with the installed fire barrier cap shown in FIG. 10, these variances are represented in FIGS. 20B-20D by gaps between the outer intumescent strips and the opening edge of the front wallboard, both above and below the protruding ring of the mounted fire barrier cap. These gaps do not impair the fire resistance rating obtained through the using the fire barrier cap. In a fire condition, the outer intumescent strip greatly expands to entirely fill any gaps between the outer edges of the fire barrier cap and the perimeter of the shower fixture opening formed in the front wallboard (see FIG. 17 as an example).

Although mentioned already herein, it is worth again noting that in an embodiment, the disclosed system allows the fire barrier penetration sealer to be easily centered in oversize holes cut in the barrier/Moreover, in a further aspect, aperture tabs may be used to allow easy centering of the fire barrier penetration sealer on the penetrating valve or other object. For example, the penetrating object may be any mechanism and may be metallic or nonmetallic or a combination thereof without limitation.

Moreover, it is worth reiterating that various embodiments of the disclosed system, as illustrated herein, may be installed in back-to-back installation without interfering with one another. Embodiments are also able to be installed in a shaft wall, improving over many existing attempted solutions.

As various changes could be made in the above constructions without departing from the scope of the disclosed principles, it is intended that all the matter contained in the above description or shown in the accompanying drawings shall be interpreted as illustrative and not in a limiting sense.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “such that,” and “operable to” do not imply any particular tangible or intangible modification of a subject, but, rather, are intended to be used interchangeably. A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology.

A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The words “exemplary,” “exemplify,” and “example” are used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub combination or variation of a sub combination.

It will be appreciated that various systems and processes have been disclosed herein. However, in view of the many possible embodiments to which the principles of the present disclosure may be applied, it should be recognized that the embodiments described herein with are meant to be illustrative only and should not be taken as limiting the scope of the claims. Therefore, the techniques as described herein contemplate all such embodiments as may come within the scope of the following claims and equivalents thereof.

We claim:

1. A fire barrier penetration sealer for sealing an opening in a fire barrier at a penetration of an object through the fire barrier, the fire barrier penetration sealer comprising:
an annular face plate having a front face and a back face, as well as a primary faceplate axis;
a cylindrical projection connected to and extending from the back face of the annular face plate and having a primary axis substantially concentric with the primary faceplate axis, the cylindrical projection having an inner surface and an outer surface;
an inner intumescent strip substantially covering the inner surface of the cylindrical projection; and
an outer intumescent strip substantially covering the outer surface of the cylindrical projection, such that the annular face plate and the connected cylindrical projection fit over and at least partly surround the object penetrating the fire barrier wall when the fire barrier penetration sealer is placed over the opening in the fire barrier with its front face facing outward.

2. The fire barrier penetration sealer in accordance with claim 1, wherein the fire barrier is one of a wall, a floor and a ceiling.

3. The fire barrier penetration sealer in accordance with claim 1, wherein the object penetrating the fire barrier is a plumbing fixture.

4. The fire barrier penetration sealer in accordance with claim 3, wherein the plumbing fixture is a water valve including a stem.

5. The fire barrier penetration sealer in accordance with claim 4, wherein a space between the inner intumescent strip and the water valve provides access to one or more shutoff screws on the water valve.

6. The fire barrier penetration sealer in accordance with claim 1, wherein the inner intumescent strip comprises 3M™ FSI95.

7. The fire barrier penetration sealer in accordance with claim 1, wherein the outer intumescent strip comprises 3M™ Ultra GS.

8. The fire barrier penetration sealer in accordance with claim 1, wherein the penetration is in one of a corridor, a demising wall and a stack wall.

9. The fire barrier penetration sealer in accordance with claim 1, wherein the faceplate is adapted to allow centering of the fire barrier penetration sealer in an oversize hole in the barrier.

10. The fire barrier penetration sealer in accordance with claim 1, wherein the intumescent strip allow the fire barrier penetration sealer to be installed without the use of fastening or caulking material.

11. The fire barrier penetration sealer in accordance with claim 10, wherein the fire barrier penetration sealer may be uninstalled or have its position adjusted after installation.

12. The fire barrier penetration sealer in accordance with claim 1, further comprising aperture tabs to facilitate centering of the fire barrier penetration sealer.

13. The fire barrier penetration sealer in accordance with claim 1, wherein the object penetrating through the fire barrier is a metallic or nonmetallic pipe.

14. The fire barrier penetration sealer in accordance with claim 1, wherein the fire barrier penetration sealer is configured for back to back installation with another fire barrier penetration sealer of the same type.

15. A wall penetration sealer for fireproofing a penetration in a wall by an object, the wall penetration sealer comprising:
A face plate having a front face and a back face, as well as a primary faceplate axis;
A continuous projection connected to and extending from the back face of the face plate and having a primary axis substantially concentric with the primary faceplate axis, the projection having an inner surface and an outer surface;
an inner intumescent strip substantially covering the inner surface of the projection; and
an outer intumescent strip substantially covering the outer surface of the projection, such that the face plate and the connected projection fit over and at least partly surround the penetrating object when the wall penetration sealer is placed over the opening in the wall with its front face facing outward.

16. The wall penetration sealer in accordance with claim 15, wherein the object penetrating the fire barrier is a plumbing fixture.

17. The wall penetration sealer in accordance with claim 16, wherein the plumbing fixture is a water valve.

18. The wall penetration sealer in accordance with claim 16, wherein a space between the inner intumescent strip and the water valve provides front access to one or more shutoff screws on the water valve.

19. The wall penetration sealer in accordance with claim 15, wherein the penetration is in one of a corridor, a demising wall and a stack wall.

20. The wall penetration sealer in accordance with claim 15, wherein the wall penetration sealer is configured for back to back installation with another wall penetration sealer of the same type.
